(19) United States
(12) Patent Application Publication
(10) Pub. No.: US 2023/0003858 A1
(43) Pub. Date: Jan. 5, 2023

(54) LIDAR WITH THERMAL PHASE SHIFTER

(71) Applicant: Seagate Technology LLC, Fremont, CA (US)

(72) Inventors: Aditya Jain, Minneapolis, MN (US); Zoran Jandric, St. Louis Park, MN (US); Neil Zuckerman, Eden Prairie, MN (US)

(21) Appl. No.: 17/850,071

(22) Filed: Jun. 27, 2022

Related U.S. Application Data
(60) Provisional application No. 63/215,702, filed on Jun. 28, 2021.

(51) Int. Cl. G01S 7/4911; G01S 7/481; G01B 11/24; G01S 17/06; G01S 17/50

(52) U.S. Cl. CPC G01S 7/4911; G01S 7/4815; G01B 11/24; G01S 17/06; G01S 17/50

(57) ABSTRACT

A light detection and ranging system can have an array of solid-state optical energy emitters coupled to a controller and at least one antennae. Each emitter may be coupled to a phase shifter that has a first waveguide and a second waveguide with a heating element continuously extending between the respective waveguides.

### SUMMARY

Light detection and ranging can be optimized, in various embodiments, by arranging an array of solid-state optical energy emitters coupled to a controller and at least one antennae. Each emitter is coupled to a phase shifter that has a first waveguide and a second waveguide with a heating element continuously extending between the respective waveguides.

### BRIEF DESCRIPTION OF THE DRAWINGS

FIG. 1 is a block representation of an example environment in which assorted embodiments can be practiced.

FIG. 2 plots operational information for an example detection system configured in accordance with some embodiments.

FIGS. 3A & 3B respectively depict portions of an example detection system arranged and operated in accordance with various embodiments.

FIG. 4 depicts portions of an example detection system constructed and employed in accordance with some embodiments.

FIG. 5 depicts a block representation of portions of an example detection system employed in accordance with assorted embodiments.

FIG. 6 depicts a block representation of portions of an example solid-state optical emitter that can be utilized in various embodiments.

FIG. 7 depicts portions of an example optical ranging and detection system that can be operated in accordance with some embodiments.

FIG. 8 depicts a block representation of portions of an example solid-state optical emitter arranged to carry out assorted embodiments.

FIGS. 9A & 9B respectively depict line representations of portions of an example ranging and detection system utilized with in various embodiments.

### DETAILED DESCRIPTION

Various embodiments of the present disclosure are generally directed to optimization of an active light detection system through the utilization of thermal energy.

Advancements in computing capabilities have corresponded with smaller physical form factors that allow intelligent systems to be implemented into a diverse variety of environments. Such intelligent systems can complement, or replace, manual operation, such as with the driving of a vehicle or flying a drone. The detection and ranging of stationary and/or moving objects with radio or sound waves can provide relatively accurate identification of size, shape, and distance. However, the use of radio waves (300 GHz-3 kHz) and/or sound waves (20 kHZ-200 kHz) can be significantly slower than light waves (430-750 Terahertz), which can limit the capability of object detection and ranging while moving.

The advent of light detection and ranging (LiDAR) systems employ light waves that propagate at the speed of light to identify the size, shape, location, and movement of objects with the aid of intelligent computing systems. The ability to utilize multiple light frequencies and/or beams concurrently allows LiDAR systems to provide robust volumes of information about objects in a multitude of environmental conditions, such as rain, snow, wind, and darkness. Yet, current LiDAR systems can suffer from inefficiencies and inaccuracies during operation that jeopardize object identification as well as the execution of actions in response to gathered object information. Hence, embodiments are directed to structural and functional optimization of light detection and ranging systems to provide increased reliability, accuracy, safety, and efficiency for object information gathering.

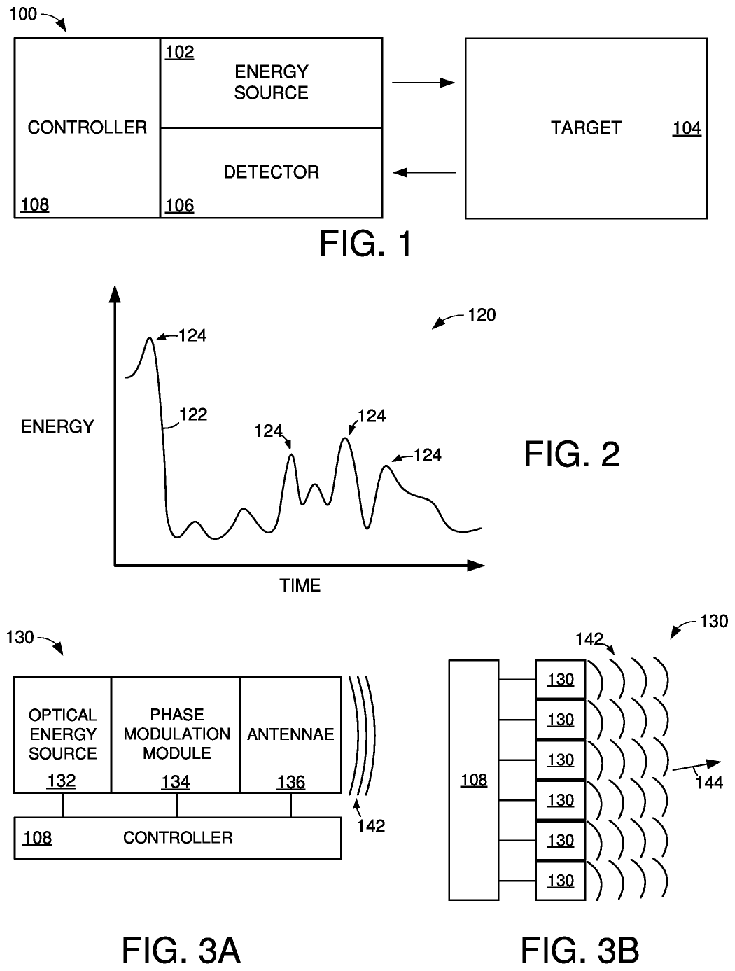

FIG. 1 depicts a block representation of portions of an example object detection environment 100 in which assorted embodiments can be practiced. One or more energy sources 102, such as a laser or other optical emitter, can produce photons that travel at the speed of light towards at least one target 104 object. The photons bounce off the target 104 and are received by one or more detectors 106. An intelligent controller 108, such as a microprocessor or other programmable circuitry, can translate the detection of returned photons into information about the target 104, such as size and shape.

The use of one or more energy sources 102 can emit photons over time that allow the controller 108 to track an object and identify the target's distance, speed, velocity, and direction. FIG. 2 plots operational information for an example light detection and ranging system 120 that can be utilized in the environment 100 of FIG. 1. Solid line 122 conveys the volume of photons received by a detector over time. The greater the intensity of returned photons (Y axis) can be interpreted by a system controller as surfaces and distances that that can be translated into at least object size and shape.

It is contemplated that a system controller can interpret some, or all, of the collected photon information from line 122 to determine information about an object. For instance, the peaks 124 of photon intensity can be identified and used alone as part of a discrete object detection and ranging protocol. A controller, in other embodiments, can utilize the entirety of photon information from line 122 as part of a full waveform object detection and ranging protocol. Regardless of how collected photon information is processed by a controller, the information can serve to locate and identify objects and surfaces in space in front of the light energy source.

FIGS. 3A & 3B respectively depict portions of an example light detection assembly 130 that can be utilized in a light detection and ranging system 140 in accordance with various embodiments. In the block representation of FIG. 3A, the light detection assembly 130 consists of an optical energy source 132 coupled to a phase modulation module 134 and an antennae 136 to form a solid-state light emitter and receiver. Operation of the phase modulation module 134 can direct beams of optical energy in selected directions relative to the antennae 136, which allows the single assembly 130 to stream one or more light energy beams in different directions over time.

FIG. 3B conveys an example optical phase array (OPA) system 140 that employs multiple light detection assemblies 130 to concurrently emit separate optical energy beams 142 to collect information about any downrange targets 104. It is contemplated that the entire system 140 is physically present on a single system on chip (SOC), such as a silicon substrate. The collective assemblies 130 can be connected to one or more controllers 108 that direct operation of the light energy emission and target identification in response to detected return photons. The controller 108, for example, can direct the steering of light energy beams 142 to a particular direction 144, such as a direction that is non-normal to the antennae 138, like 45°.

The use of the solid-state OPA system 140 can provide a relatively small physical form factor and fast operation, but can be plagued by interference and complex processing that jeopardizes accurate target 104 detection. For instance, return photons from different beams 142 may cancel, or alter, one another and result in an inaccurate target detection. Another non-limiting issue with the OPA system 140 stems from the speed at which different beam 142 directions can be executed, which can restrict the practical field of view of an assembly 130 and system 140.

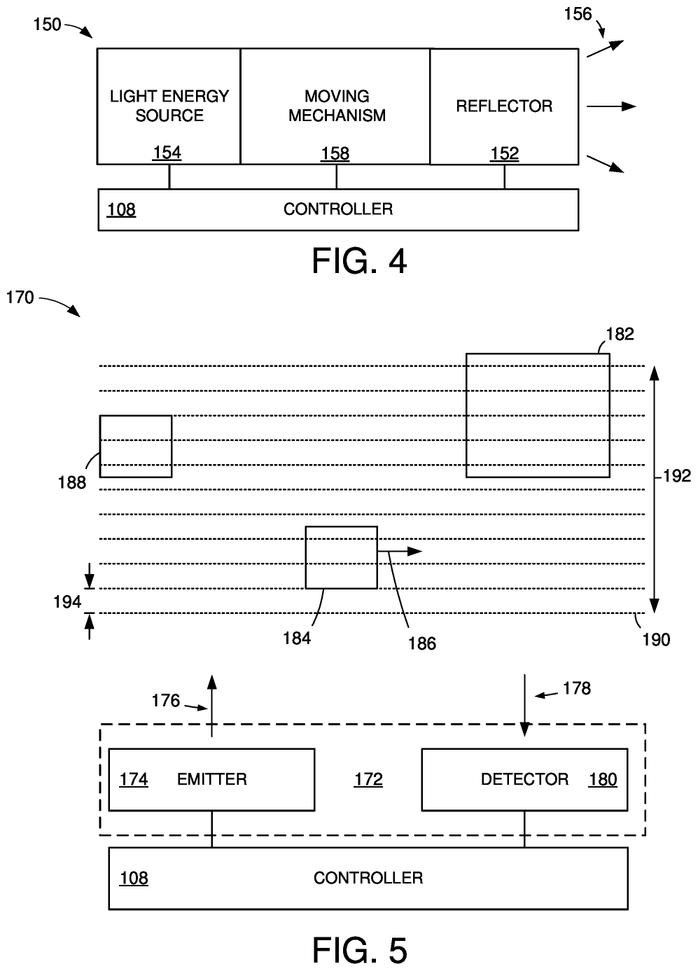

FIG. 4 depicts a block representation of a mechanical light detection and ranging system 150 that can be utilized in assorted embodiments. In contrast to the solid-state OPA system 140 in which all components are physically stationary, the mechanical system 150 employs a moving reflector 152 that distributes light energy from a source 154 downrange towards one or more targets 104. While not limiting or required, the reflector 152 can be a single plane mirror, prism, lens, or polygon with reflecting surfaces. Controlled movement of the reflector 152 and light energy source 154, as directed by the controller 108, can produce a continuous, or sporadic, emission of light beams 156 downrange.

Although the mechanical system 150 can provide relatively fast distribution of light beams 156 in different directions, the mechanism to physically move the reflector 152 can be relatively bulky and larger than the solid-state OPA system 140. The physical reflection of light energy off the reflector 152 also requires a clean environment to operate properly, which restricts the range of conditions and uses for the mechanical system 150. The mechanical system 150 further requires precise operation of the reflector 152 moving mechanism 158, which may be a motor, solenoid, or articulating material, like piezoelectric laminations.

FIG. 5 depicts a block representation of an example detection system 170 that is configured and operated in accordance with various embodiments. A light detection and ranging assembly 172 can be intelligently utilized by a controller 108 to detect at least the presence of known and unknown targets downrange. As shown, the assembly 172 employs one or more emitters 174 of light energy in the form of outward beams 176 that bounce off downrange targets and surfaces to create return photons 178 that are sensed by one or more assembly detectors 180. It is noted that the assembly 172 can be physically configured as either a solid-state OPA or mechanical system to generate light energy beams 172 capable of being detected with the return photons 178.

Through the return photons 178, the controller 108 can identify assorted objects positioned downrange from the assembly 172. The non-limiting embodiment of FIG. 5 illustrates how a first target 182 can be identified for size, shape, and stationary arrangement while a second target 184 is identified for size, shape, and moving direction, as conveyed by solid arrow 186. The controller 108 may further identify at least the size and shape of a third target 188 without determining if the target 188 is moving.

While identifying targets 182/184/188 can be carried out through the accumulation of return photon 178 information, such as intensity and time since emission, it is contemplated that the emitter(s) 174 employed in the assembly 172 stream light energy beams 176 in a single plane, which corresponds with a planar identification of reflected target surfaces, as identified by segmented lines 190. By utilizing different emitters 174 oriented to different downrange planes, or by moving a single emitter 174 to different downrange planes, the controller 108 can compile information about a selected range 192 of the assembly's field of view. That is, the controller 108 can translate a number of different planar return photons 178 into an image of what targets, objects, and reflecting surfaces are downrange, within the selected field of view 192, by accumulating and correlating return photon 178 information.

The light detection and ranging assembly 172 may be configured to emit light beams 176 in any orientation, such as in polygon regions, circular regions, or random vectors, but various embodiments utilize either vertically or horizontally single planes of beam 176 dispersion to identify downrange targets 182/184/188. The collection and processing of return photons 178 into an identification of downrange targets can take time, particularly the more planes 190 of return photons 178 are utilized. To save time associated with moving emitters 174, detecting large volumes of return photons 178, and processing photons 178 into downrange targets 182/184/188, the controller 108 can select a planar resolution 194, characterized as the separation between adjacent planes 190 of light beams 176.

In other words, the controller 108 can execute a particular downrange resolution 194 for separate emitted beam 176 patterns to balance the time associated with collecting return photons 178 and the density of information about a downrange target 182/184/188. As a comparison, tighter resolution 194 provides more target information, which can aid in the identification of at least the size, shape, and movement of a target, but bigger resolution 194 (larger distance between planes) can be conducted more quickly. Hence, assorted embodiments are directed to selecting an optimal light beam 176 emission resolution to balance between accuracy and latency of downrange target detection.

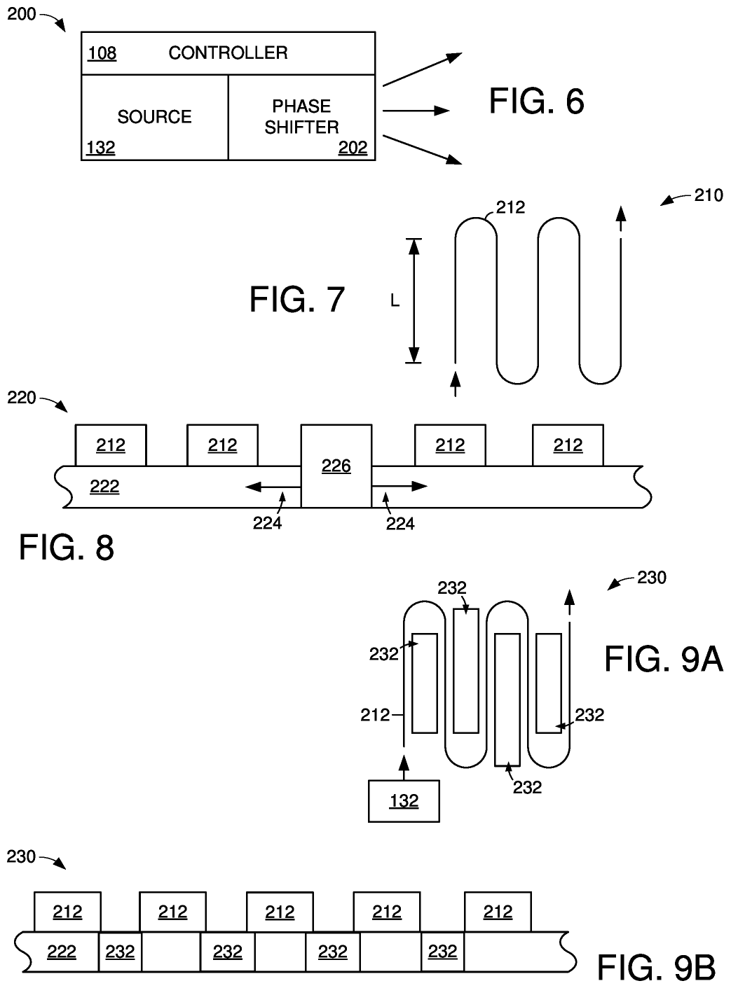

FIG. 6 depicts a block representation of portions of an example solid-state OPA emitter 200 arranged in accordance with various embodiments to employ a phase shifter 202 to alter the direction light energy is deployed. As shown by solid arrows, control of the phase shifter 202 by a local, or remote, controller 108 can provide dynamic angular range for emitted light energy. Utilization of the phase shifter 202 allows a wider field of view and range of detection than simply emitting light energy in a single plane and angular orientation relative to the light source 132. However, the use of a phase shifter 202 can pose operational inefficiencies as changing the angle of emitted light adds time delays.

FIG. 7 depicts portions of an example phase shifter 210 that can be incorporated into solid-state OPA emitter in some embodiments. The phase shifter 210 can employ any number of waveguides 212 that are configured to alter the phase of light energy passing from an input to an output portion of the waveguide 212. Customization of the waveguide 212, such as length (L), cross-sectional shape, and size provide tuned operation and reliable alteration of the phase of light energy to control the relative direction of light from a source 132. Yet, a tuned waveguide 212 is viable for a single angular direction relative to the source 132. That is, passage of light energy through the waveguide 212 can reliably alter light beam emission to a single direction, which can be inefficient when several different waveguides 212 are selectively utilized to disperse light energy in a range of different directions.

FIG. 8 depicts a block representation of portions of an example phase shifter 220 that can be utilized in a solid-state OPA emitter to provide a range of light beam steering directions. One or more waveguides 212 can extend proximal a rib 222 that carries at least heat 224 in response to activation of a heat core 226. Although not required or limiting, the heat core 226 can be a doped waveguide that reacts to the application of electricity and/or light energy by emitting heat along the rib 222. It is noted that the application of thermal energy (heat) 224 to a waveguide 212 can temporarily alter the shifting of light energy phase, which effectively customizes the direction of light energy emission from the waveguide 212.

The non-limiting example phase shifter 230 illustrates how a single pass heat core 226 can provide thermal energy. However, it is noted that such a configuration can be relatively power hungry, which can lead to inefficiencies in providing a range of light energy emission angles relative to a source. For instance, 60 mW or more may be necessary to produce sufficient thermal energy and waveguide customization to provide a 2 π phase shift for light energy carried by the waveguide(s) 212. In an OPA with numerous phase shifters 220, such as approximately 1024 thermal phase shifters, the total power consumption can be unsustainable. Accordingly, various embodiments are directed to structures that provide more efficient and reliable application of thermal energy to a phase shifter 220.

FIGS. 9A & 9B respectively depict portions of an example phase shifter 230 that can be employed as part of a solid-state OPA in accordance with various embodiments. The phase shifter 230 employs thermal energy 224 to alter the phase of optical energy in an OPA and the direction of the light emission relative to a light source 132. FIG. 9A displays how a waveguide 212 can be influenced by one or more heating elements 232 that provide at least a 2 90 phase shift for light energy with considerably less power than the single pass heat core 226 of FIG. 8. As an example, physically passing a common heater 232 proximal to greater surface area than the single pass heater 226 allows 5 mW or less of energy to produce up to a 2 π phase shift for light energy passing through the waveguide 212.

FIG. 9B illustrates how positioning heating elements 232 along a rib 222 with greater exposure to the waveguide 212 can apply thermal energy with enhanced efficiency compared to the single pass heater 226 of FIG. 8. In some embodiments, the heating elements 232 are a single, serpentine arrangement that is wholly activated as a uniform unit. It is contemplated that multiple separate portions of a single rib 222 are doped to become heaters 232 in response to the application of electricity. It is noted, however, that any number of separate heaters 232 can be utilized with similar, or dissimilar, configurations, such as size, cross-sectional shape, and/or position proximal the waveguide 212. With physically smaller cross-sectional areas and greater exposure to the waveguide 212 for the heating elements 232 compared to the single pass heat core 226, a lower amount of applied electricity can produce sufficient thermal energy to produce up to a 2 π phase shift for light energy. The relatively small size of the heating elements 232 may further allow for quicker cooling than a single pass heat core 226, which can provide more efficient and quicker transition between different light beam steering angles produced by the phase shifter 230.

Various non-limiting embodiments arrange a single heating element 232 with varying heating characteristics along the length of the rib 222 to provide a non-uniform application of thermal energy to different aspects of the waveguide 212. For instance, a middle section of a rib 222, and waveguide 212 can be configured to release greater volumes of thermal energy than lateral sections of the rib 222, which can create a predetermined thermal gradient upon activation of the heating element 232 and customize thermal dissipation immediately after electricity ceases passing through the heating element 232.

It is contemplated that a 2 π phase shift for light energy can be obtained by using serpentine heaters 232 that recycle thermal energy over multiple waveguides 212. These multiple waveguides 212 can be placed in close proximity to each other to heat the waveguides more efficiently. Some embodiments employ multiple ribs 222 for customized thermal conduction between adjacent waveguides 212. It is contemplated that a middle waveguide is heavily doped to act as a heater in response to current passing through it. Multiple waveguides 212 can be configured with dissimilar widths to reduce evanascent coupling between the waveguides.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

What is claimed is:

1. An apparatus comprising a solid-state optical energy emitter coupled to a controller and a phase shifter, the phase shifter comprising a heating element positioned between portions of a waveguide.

2. The apparatus of claim 1, wherein the solid-state optical energy emitter is part of an array of multiple solid-state optical energy emitters physically packaged together.

3. The apparatus of claim 1, wherein the solid-state optical energy emitter and controller are each coupled to at least one antennae.

4. The apparatus of claim 1, wherein the heating element has a serpentine shape.

5. The apparatus of claim 5, wherein the waveguide has a serpentine shape.

6. The apparatus of claim 1, wherein the waveguide and heating element do not intersect.

7. The apparatus of claim 1, wherein the heating element comprises a doped rib waveguide.

8. The apparatus of claim 1, wherein the heating element is a singular unit disposed between multiple different waveguides.

9. The apparatus of claim 8, wherein the different waveguides respectively have different widths corresponding with different light energy frequency propagation.

10. The apparatus of claim 1, wherein a center portion of the heating element has a different cross-sectional area than a lateral portion.

11. A method comprising:
positioning a solid-state optical energy emitter downrange from a target, the solid-state optical energy emitter coupled to a controller and a phase shifter, the phase shifter comprising a heating element positioned between portions of a waveguide;
passing light energy through the waveguide with a first phase by activating an optical source; and
activating the phase shifter to provide a 2 π phase shift for the light energy passing through the waveguide.

12. The method of claim 11, wherein the phase shifter is activated by passing electrical current through a heating element.

13. The method of claim 12, wherein the heating element is positioned proximal the waveguide so that 5 mW of electricity produces the 2 π phase shift for the light energy.

14. The method of claim 11, wherein the activation of the phase shifter alters a light beam direction from the solid-state optical energy emitter.

15. The method of claim 11, wherein the light energy is sensed by a detector to identify a position of the target.

16. The method of claim 11, wherein the light energy is sensed by a detector to identify a movement vector of the target.

17. The method of claim 11, wherein the light energy is sensed by a detector to identify a shape of the target.

18. The method of claim 11, wherein the phase shifter is configured to provide a non-uniform thermal gradient from a first side of the waveguide to a second side.

19. A light ranging and detection system comprising a plurality of solid-state optical energy emitters each coupled to a controller and a phase shifter, each phase shifter comprising a heating element positioned between portions of a waveguide.

20. The light ranging and detection system of claim 19, wherein 1024 phase shifters provide thermal energy to at least 512 waveguides.
